(19) United States
(12) Patent Application Publication
(10) Pub. No.: US 2014/0227069 A1
(43) Pub. Date: Aug. 14, 2014

(54) TRANSFER CONVEYOR AND FARM IMPLEMENT FOR TRANSPORTING SAME

(71) Applicant: UNVERFERTH MANUFACTURING COMPANY, INC., Kalida, OH (US)

(72) Inventors: Steven R. HILVERS, Delphos, OH (US); Shawn GERDEMAN, Kalida, OH (US); David R. SMITH, Fort Jennings, OH (US)

(73) Assignee: Unverferth Manufacturing Company, Inc., Kalida, OH (US)

(21) Appl. No.: 13/765,592

(22) Filed: Feb. 12, 2013

(51) Int. Cl. B60P 1/00

(52) U.S. Cl. CPC B60P 1/00
USPC 414/332; 414/398; 414/523

(57) ABSTRACT

A system for transferring material from a storage container to a farm implement includes a transfer conveyor transportable on a farm implement including a trailer, a bin mounted on the trailer, a cart conveyor, and a dock mounted on the trailer forwardly or rearwardly of the bin to stow the transfer conveyor. The transfer conveyor includes a wheeled receptacle defining a receiving area with an open top and first and second conveyor portions. The first conveyor portion is disposed within the receiving area and the second conveyor portion pivotable between a storage position in which the second conveyor portion is positioned across the top of the receptacle and an operating position in which the second conveyor portion extends outwardly from the receptacle. The dock is mounted to pivot from a horizontal stowed position disposed across the trailer to a tilted deployed position extending from the trailer to the ground to allow the transfer conveyor to be loaded onto and unloaded from the trailer.

### BACKGROUND OF THE INVENTION

1. Field of the Invention

The present invention relates generally to farm equipment, and more particularly, to an apparatus and method for transferring agricultural material from a storage bin or container to farm equipment, such as a seed tender,

2. Description of the Related Art

Transfer conveyors are generally used to assist in the transfer of material from a storage bin or container to another bin or container. For example, in farming applications, transfer conveyors are sometimes used to transfer seed from a storage bin or container to a seed tender.

However, transfer conveyors known in the art are large and have to be transported separately from the other farm equipment to the work site. The transportation of the transfer conveyor requires additional workers and/or extra equipment (e.g., a truck or a trailer).

### SUMMARY OF THE PRESENT INVENTION

In accordance with a first aspect of the present invention, a transfer conveyor for transport on a farm implement with a trailer including a dock configured to store the transfer conveyor includes a receptacle defining a receiving area with an open top and a first conveyor disposed in the receiving area and configured to move material in the receiving area along an axis. The transfer conveyor further includes a second conveyor having an end pivotably coupled to the receptacle adjacent an opening in a side or bottom of the receptacle. The second conveyor is pivot able between a storage position in which the second conveyor is positioned across the open top of the receptacle and an operating position in which the second conveyor extends outwardly from the receptacle.

In an embodiment of the present invention, the receptacle includes a plurality of wheels and at least one of the plurality of wheels propels the conveyor.

In an embodiment of the present invention, an angle of the second conveyor relative to the axis of the first conveyor is adjustable in the operating position.

In an embodiment of the present invention, the receptacle also includes a sump at the bottom of the receiving area and the first conveyor is configured to convey material from the sump.

In an embodiment of the present invention, the receptacle further includes a coupling member which protrudes from the top of the receptacle adjacent the open top, and the second conveyor is pivotably coupled to the coupling member.

In another aspect of the present invention, a farm implement for transporting a transfer conveyor includes a trailer and a bin mounted on the trailer. The farm implement also includes a conveyor positionable in a loading position in which a conveyor output is positioned over the bin. The farm implement further includes a dock mounted on the trailer and configured to support a transfer conveyor. The dock is moveable between a storage position and a deployed position in which the dock is Inclined and an and of the dock contacts a ground.

In an embodiment of the present invention, the transfer conveyor is configured to be moved on and off the dock. A height of the transfer conveyor may be less than a distance between the dock and the farm implement conveyor when the cart conveyor is in a transport position.

In an embodiment of the present invention, the dock is extendable.

In an embodiment of the present invention, the trailer includes support members including a cavity in which the dock is mounted.

### BRIEF DESCRIPTION OF THE DRAWINGS

FIGS. 1-6 illustrate a seed tender and a transfer conveyor according to an embodiment of the present invention.

FIGS. 7-11 illustrate a dock in a load/unload position and a transfer conveyor moving from a stored position on a seed tender to an operating position off the seed tender according to an embodiment of the present invention.

FIGS. 12-15 illustrate a transfer conveyor in an operating position according to an embodiment of the present invention.

FIG. 16 illustrates a controller for a transfer conveyor according to an embodiment of the present invention.

FIG. 17 Illustrates a perspective view of a seed tender and a transfer conveyor according to an alternative embodiment of the present invention,

### DETAILED DESCRIPTION OF THE DRAWINGS

While the present invention may be embodied in many different forms, a number of illustrative embodiments are described herein with the understanding that the present disclosure is to be considered as providing examples and not intended to limit the invention to the preferred embodiments described and/or illustrated herein.

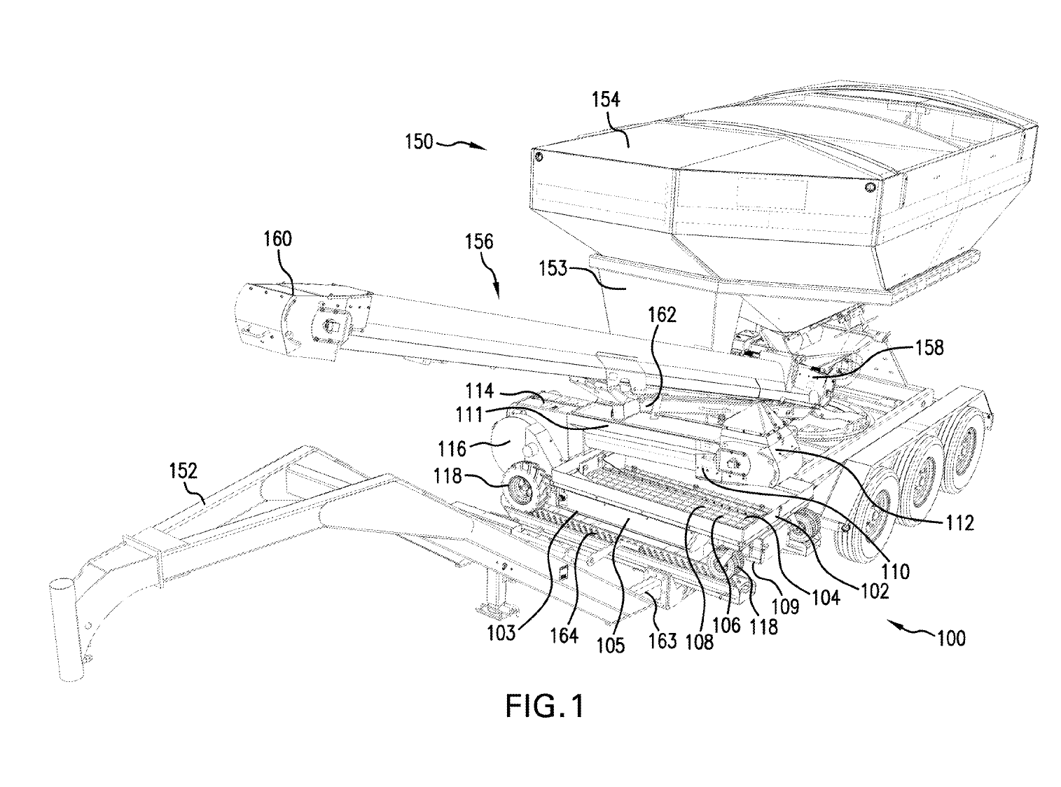

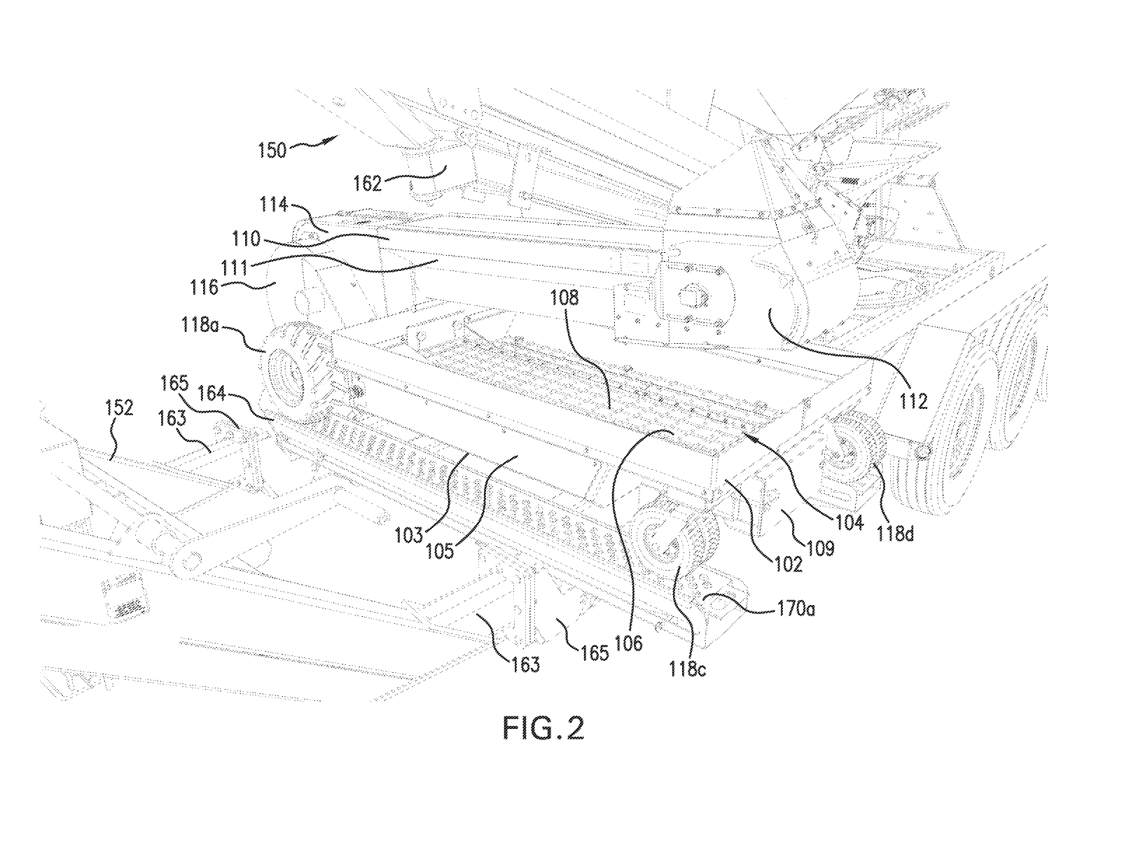

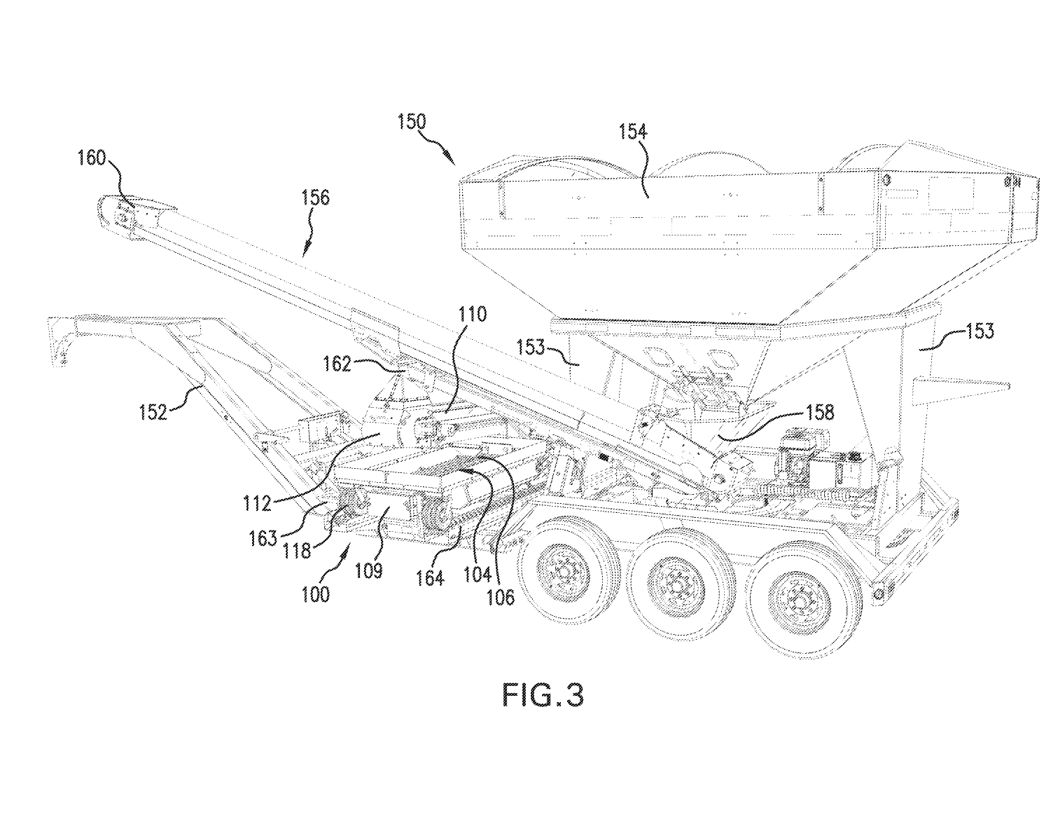

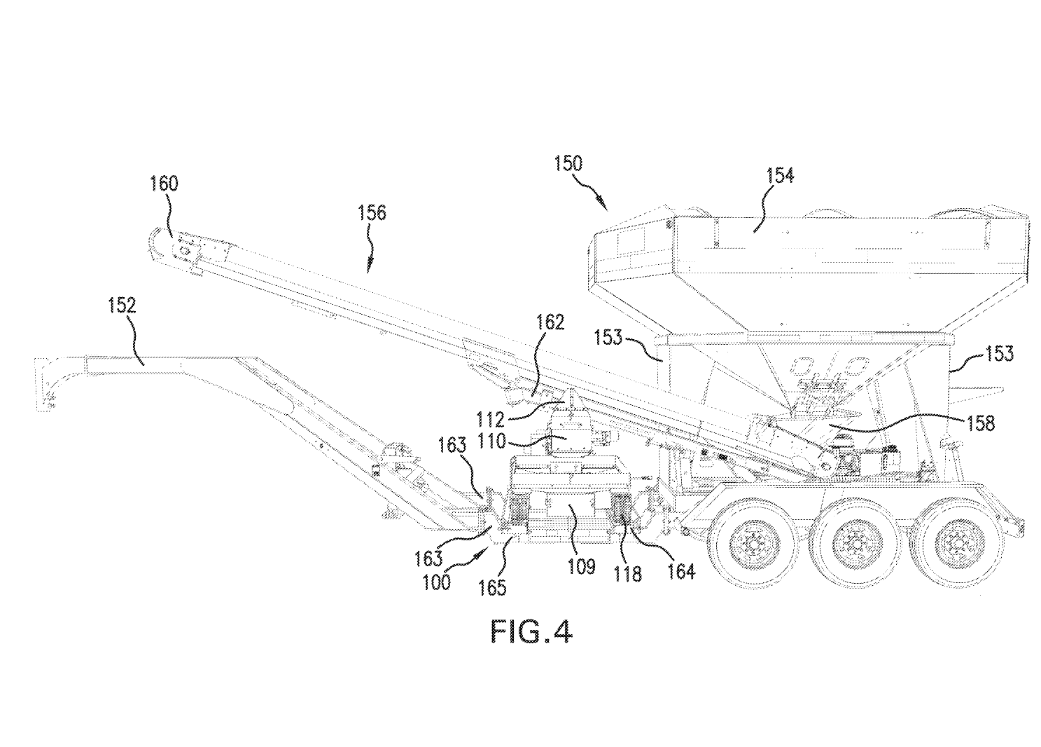

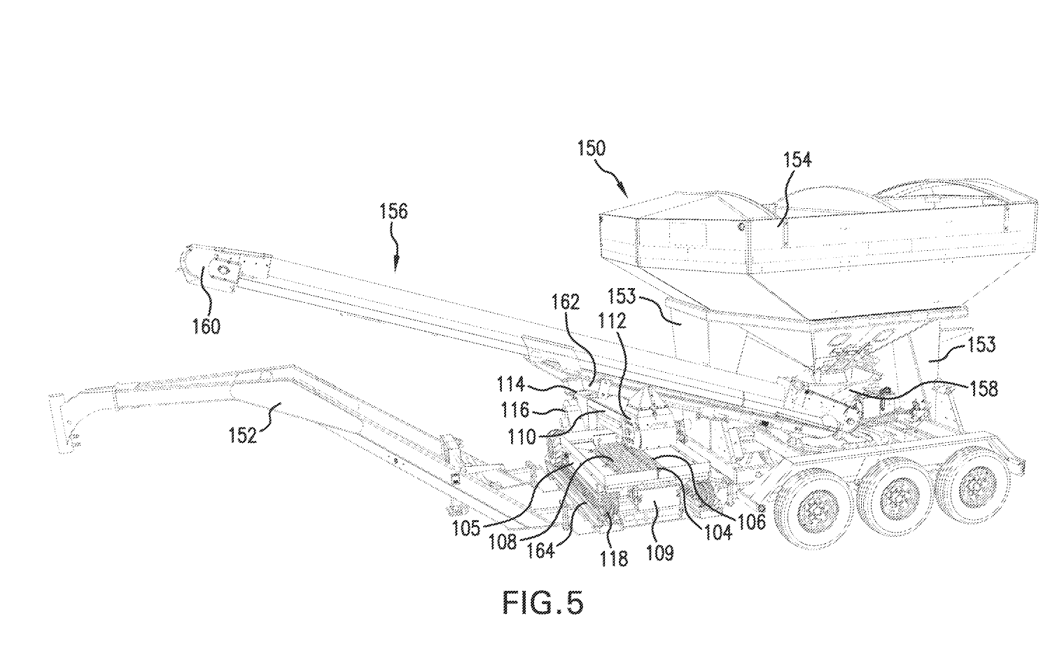

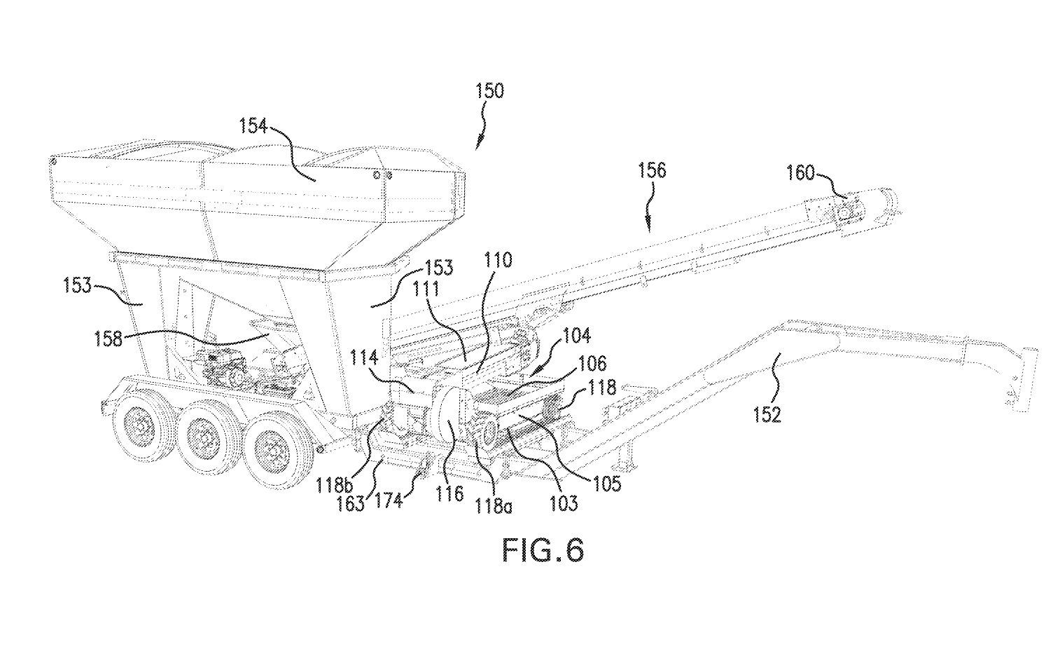

FIGS. 1-6 illustrate a towable farm implement 150 and a transfer conveyor 100 configured to be transported together according to an embodiment of the present invention. The towable farm implement 150 is shown as a seed tender with a bin 154 mounted on a trailer 152 by support members 153 and a conveyor 156. In accordance with the present invention, a portion of the towable trailer 152 extends forwardly from beneath the bin to define a storage platform for the transfer conveyor, and a ramp or dock 164 is mounted on the storage platform for movement between a horizontal stowed position on the storage platform and a tilted deployed position extending from the platform to the ground,

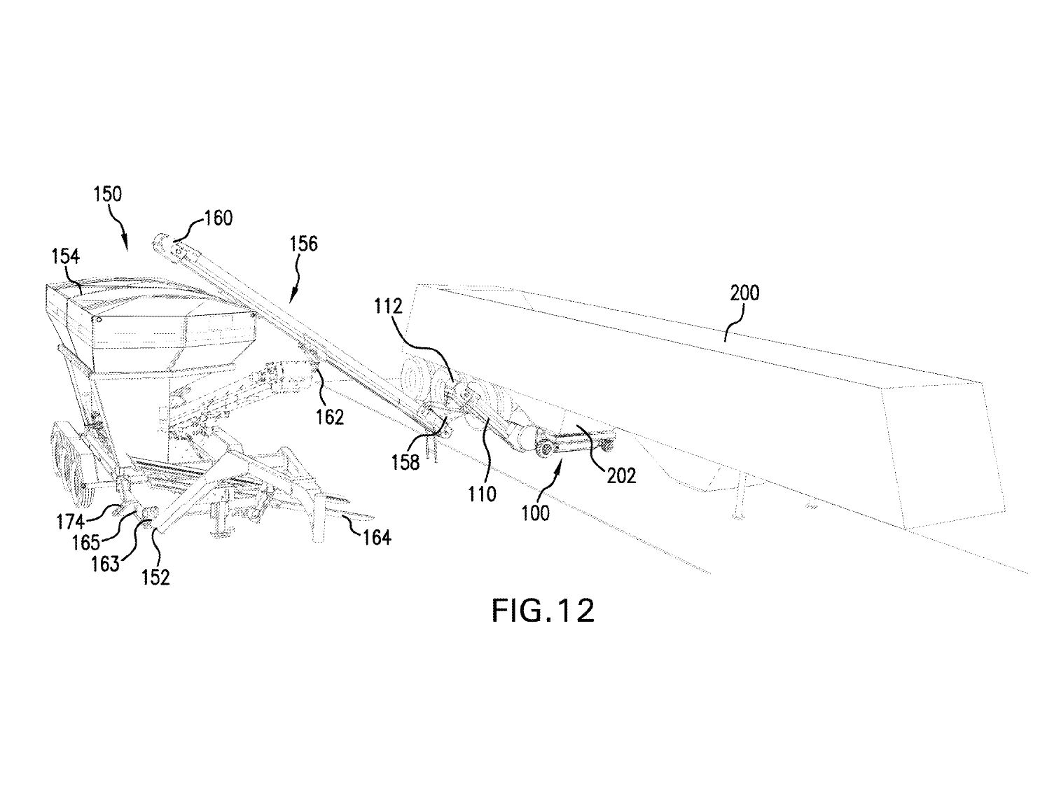

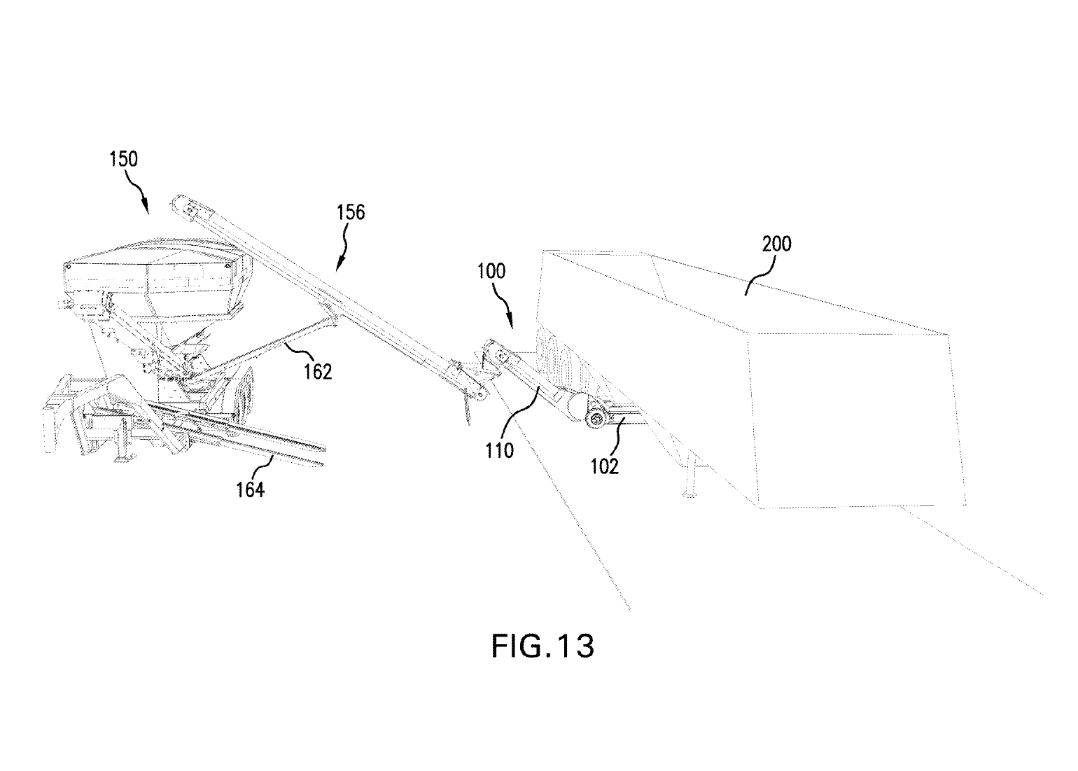

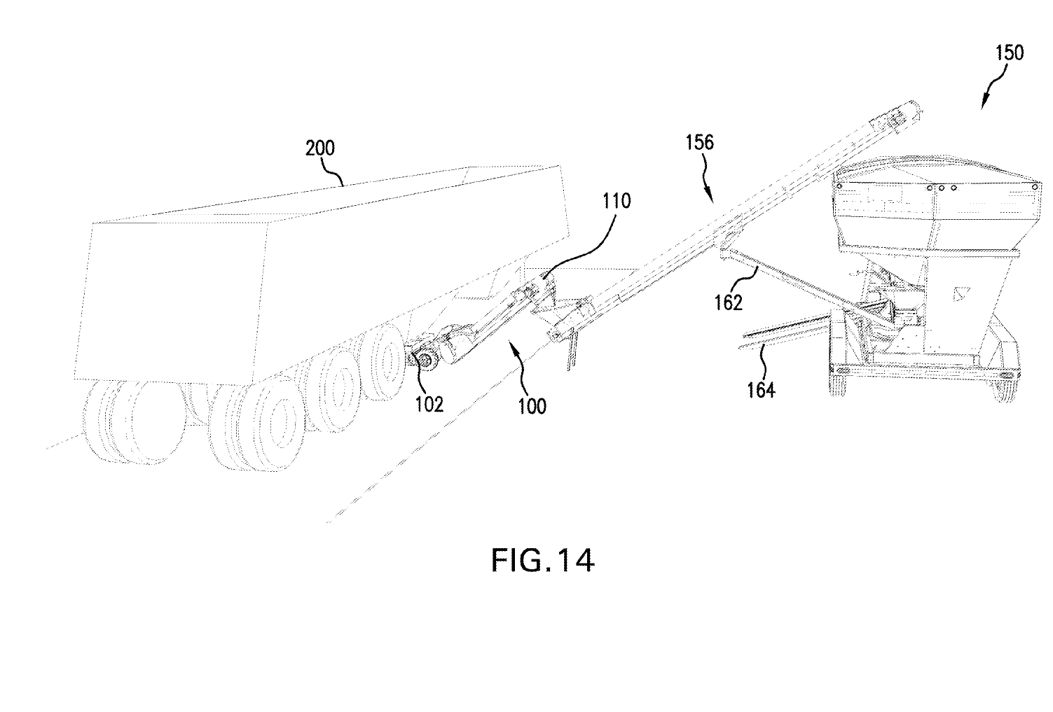

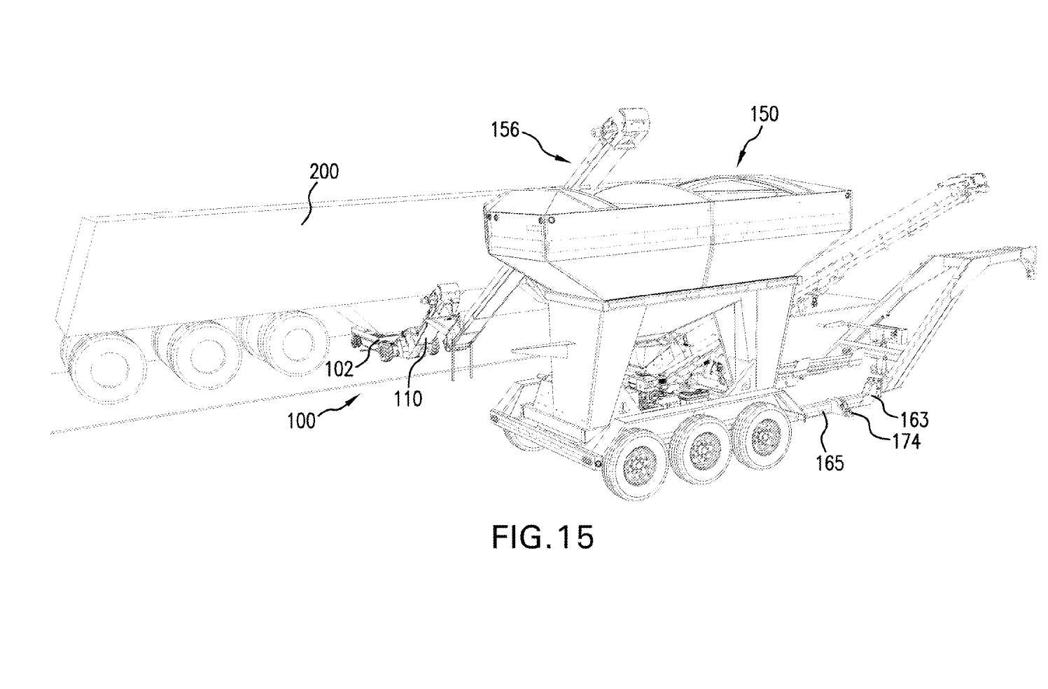

The transfer conveyor 100 includes a receptacle 102 with a base 103 and sidewalls 105 extending upwardly from the base to an opening 104 at the top of the receptacle 102. The base 103 and the sidewalls 105 define a receiving area 106 for material to be transferred via the transfer conveyor 100. The opening 104 and the receiving area 106 are configured to receive material from a discharge of a storage bin or container, such as a bin or container mounted on a trailer (see, e.g., FIGS. 12-15) or a railcar. In the example shown, the receptacle opening 104 is rectangular in shape, with a length and width larger than the discharge of the storage bin or container.

The transfer conveyor 100 is configured to transfer material, such as seed, from a storage bin to a farm implement, such as a seed tender 150, and the receiving area 106 has at least enough capacity to receive the material discharged from the storage bin without overflowing prior to transferring the material to the seed tender 150. The transfer conveyor 100 may also include a grate 108 positioned in the opening 104 to break up any material entering the conveyor and to help prevent an operator from placing his hand in the conveyor while parts are moving.

In an embodiment of the present invention, the receptacle 102 is mounted on wheels 118a-d. At least two of the wheels 118a-b at one end of the transfer conveyor 100 are motor driven. The other wheels 118c-d may be driven or un-driven. If un-driven, the wheels 118c-d are preferably mounted to also swivel about a vertical axis for maneuverability, as shown.

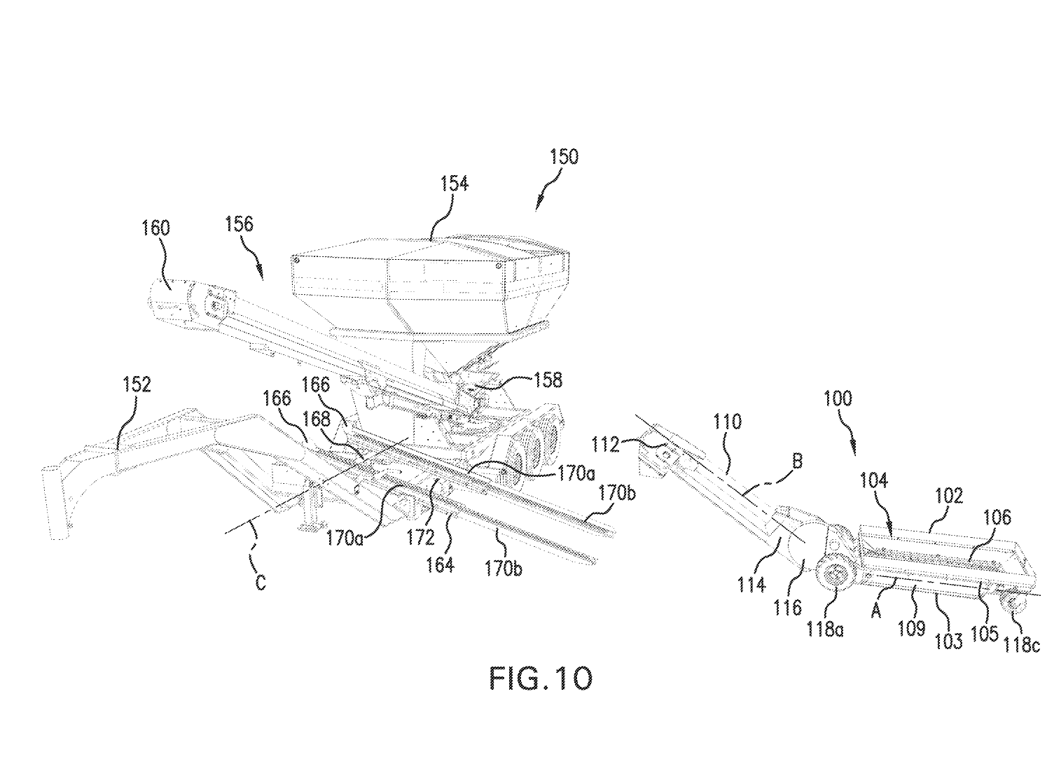

The transfer conveyor 100 also includes a first conveyor section or portion 109 disposed in receptacle 102 at the bottom of the receiving area 106 and a second conveyor section or portion 110 extending outwardly from the receptacle 102. The first conveyor portion 109 is configured to convey material along a longitudinal axis A (see FIG. 10) of the receptacle 102. In a preferred embodiment the first conveyor portion 109 is a belt conveyor with rollers configured to rotate about an axis perpendicular to longitudinal axis A and a continuous belt with a top run positioned parallel to longitudinal axis A. The second conveyor portion 110 includes a tubular housing 111 with a longitudinal axis B (see FIG. 10) and a conveyor movably disposed therein to convey material along the axis B. In a preferred embodiment, the tubular housing 111 has a circular cross-section and the conveyor inside the tubular housing is a belt conveyor with rollers configured to rotate about an axis perpendicular to longitudinal axis B and a continuous belt with a top run positioned parallel to longitudinal axis B. In an embodiment of the present invention, the cross-section of the tubular housing 111 may be rectangular, circular or any other shape suitable for conveying agricultural materials. The tubular housing 111 may also be compartmentalized such that, when the second conveyor portion 110 is a belt conveyor, a first portion of the tubular housing 111 houses a portion of the conveyor which transports material and a second portion of the tubular housing 111 houses a conveyor return portion. In an embodiment of the present invention, a motor (e,g., a hydraulic motor) drives the conveyor within the first conveyor portion 109 and the second conveyor portion 110.

A first end of the tubular housing 111 is in communication with a discharge opening in a side wall 105 of the receptacle 102, adjacent a terminal end of the first conveyor portion 109, to receive material from the receiving area 106. A second end of the tubular housing 111 carries a spout 112 for directing material from the second conveyor portion 110 to another farm implement, such as a seed tender.

The second conveyor 110 includes a discharge 112 and a first end 114 pivotably coupled to the base 102. In an embodiment of the present invention, the first end of the second conveyor 110 is pivotably coupled to the base 102 at a coupling member 116, which may be a protrusion extending from the base 102 on the face which the second conveyor 110 is adjacent in the storage position. The coupling member 116 may include an opening in which the first end of the transfer conveyor 114 is positioned.

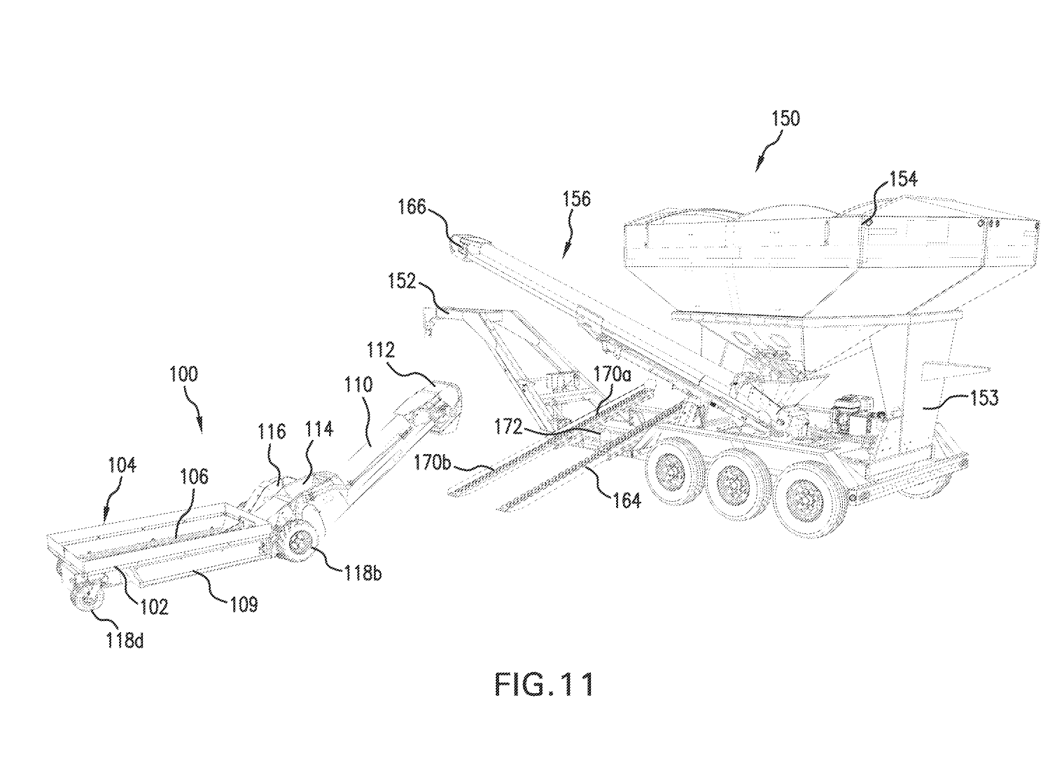

In operation, the first conveyor portion 109 conveys material out of the receptacle 102 to the second conveyor portion 110, and the second conveyor portion 110 discharges the material from the transfer conveyor 100 via spout 112. The second conveyor portion 110 is pivotable between a stored position (FIGS. 1-6) and an operating position (FIGS. 10-15). In an embodiment of the present invention, a motor (e.g., hydraulic motor) in the coupling member 116 controls the rotation of the second conveyor portion 110. In the stored position, the second conveyor 110 is positioned adjacent and across a top of the receptacle 102 and longitudinal axis Bis approximately parallel to the longitudinal axis A. In an embodiment of the present invention, the second conveyor 110 extends across the opening 104. Positioning the second conveyor portion 110 adjacent and across a top of the receptacle 102 and parallel to the first conveyor portion 109 allows the transfer conveyor 100 of the present invention to have a low profile that is much more compact than transfer conveyors known in the art, which allows the transfer conveyor 100 to be stored in locations previous transfer conveyors could not be stored, for example, on a seed tender trailer adjacent a bin mounted on the trailer and under a seed tender conveyor in a transport position, i.e., extending over the trailer (see, e.g., FIGS. 1-6). More specifically, in the embodiment shown, the profile of the transfer conveyor is low enough to fit within the generally triangular space between the seed tender trailer and the seed tender conveyor in a transport position. It will also be appreciated that the length of the transfer conveyor 100 with its second conveyor portion 110 in the storage position is such that it is less than or about equal to the width of the trailer 152 so the transfer conveyor 100 can be stored with its longitudinal axis A oriented transverse to the longitudinal axis C (see FIG. 10) of the trailer 152. This allows the transfer conveyor 100 to be integrated with the farm implement 150 during transportation and then deployed for independent operation.

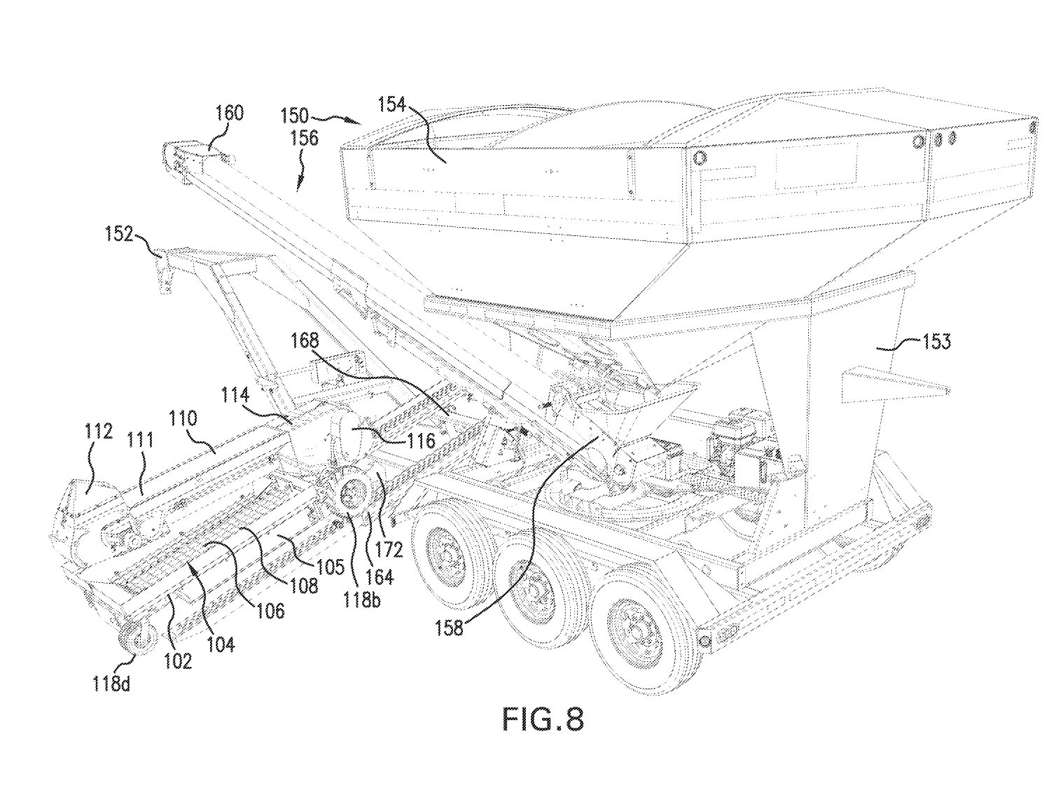

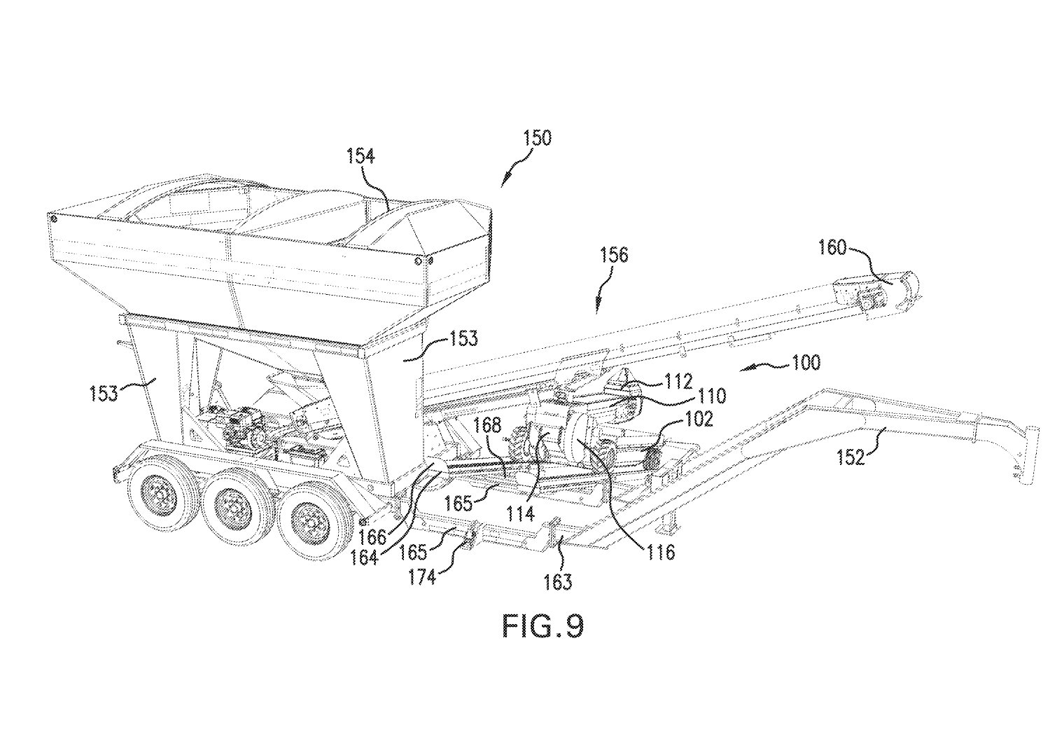

The seed tender 150 includes a trailer 152 with a gooseneck hitch, a bin 154 coupled to the trailer 152, and a seed tender conveyor 156 coupled to the seed tender by a support arm 162 that permits the conveyor to be pivoted between loading and unloading positions, e.g., as described in commonly owned US. Pat. No. 8,221,047, the disclosure of which is incorporated herein by reference in its entirety. The conveyor 156 may be positioned in an unloading position (FIGS. 1-11) in which an input end 158 of the conveyor 156 is positioned under the bin 154 and a loading position (FIGS. 12-15) in which a discharge end 160 of the conveyor 156 is positioned over the bin 154. In the unloading position, the conveyor 156 is configured to unload material from the bin 154. In the loading position, the conveyor 156 is configured to load the bin 154 with material which is loaded into the input end 156.

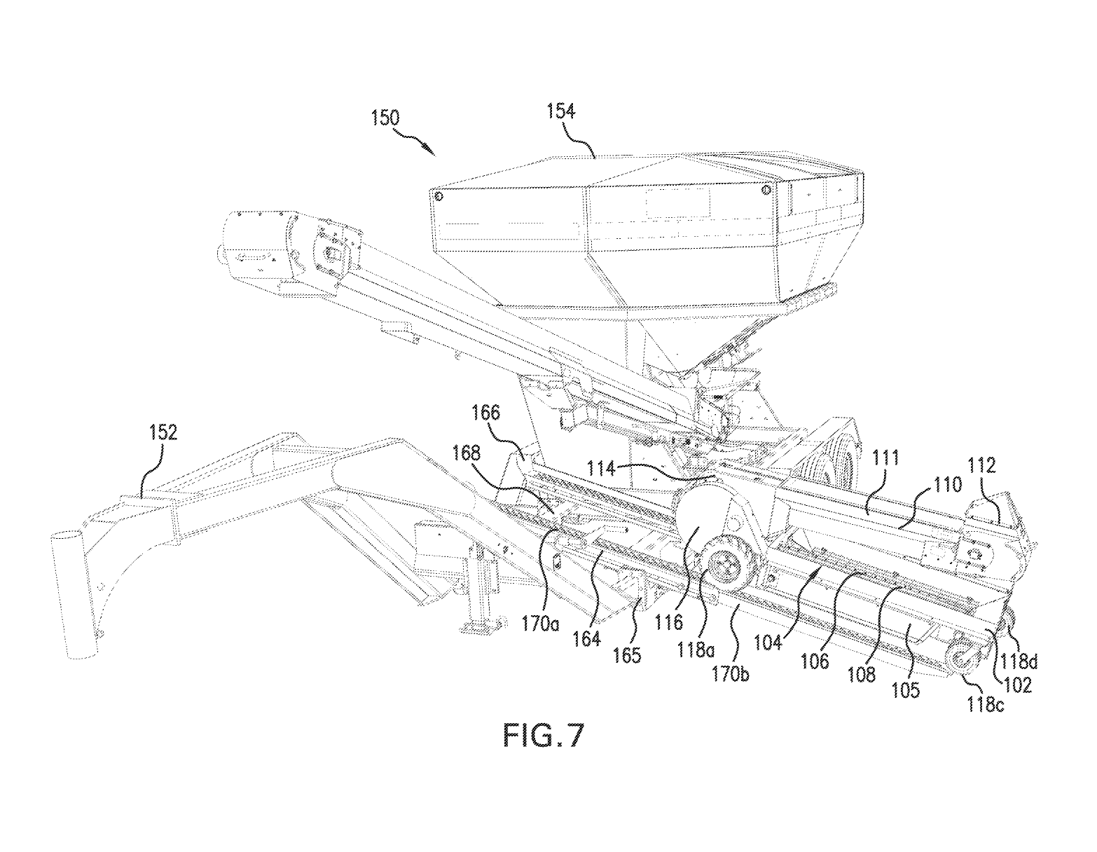

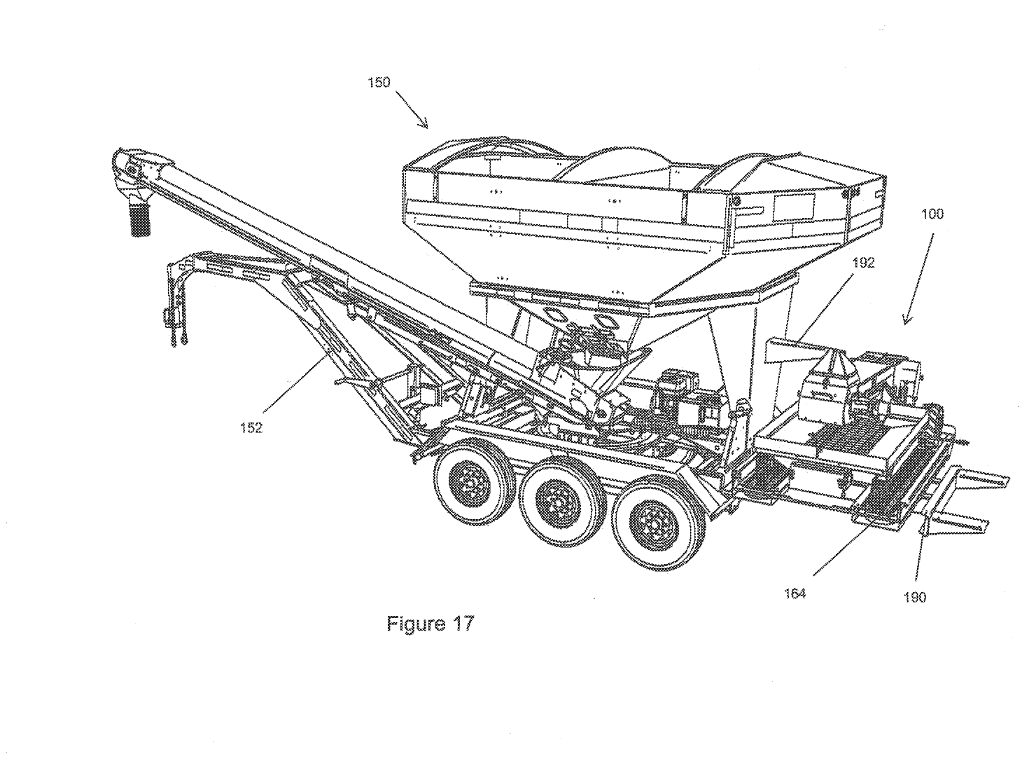

In accordance with the present invention, the seed tender 150 is also provided with a dock 164 coupled to the trailer 152. More specifically, the trailer 152 is provided with a pair of support members 163 extending forwardly of the bin 154 in a generally parallel relation to one another and the longitudinal axis C to connect with the gooseneck hitch at the front of the trailer. In an embodiment of the present invention, the support members 163 may be angled relative to each other such that the distance between the support members narrows moving away from the bin 154. In an embodiment, the support members 163 have respective depressed portions 165 in longitudinal alignment with one another to define a platform that cradles the ramp or dock 164. In the embodiment shown, the ramp or dock 164 is coupled to the support members 163 between the front of the bin 154 and the hitch. The dock 164 is configured to support the transfer conveyor 100 and can be moved between a horizontal storage position (FIGS. 1-6) extending transversely across the trailer support members 163 and an angled deployed position (FIGS. 7-15) in which the dock 164 is pivoted into an inclined orientation and extended such that an end of the dock 164 contacts the ground in order to function as a ramp. When the dock 164 is in the deployed position, the transfer conveyor 100 may move on or off the dock 164. In an alternative embodiment of the present invention, the dock 164 may be positioned at the rear of the trailer 152 between a rear of the bin 154 and the trailer bumper 192, as shown in FIG. 17. The support members 163 of the trailer may extend rearwardly beyond the bin 154 in the rear portion of the seed tender 150 to support the dock 164. In another embodiment of the present invention, a dock support member 190 may be coupled to a rear portion of the trailer 152 and extend outwardly to support the dock 164.

FIGS. 7-11 illustrate a dock in a deployed position and a transfer conveyor moving from a stored position on a seed tender to an operating position off the seed tender according to an embodiment of the present invention. In the deployed position, the dock 164 allows the transfer conveyor 100 to move off and onto the seed tender 150. The transfer conveyor 100 can move up and down the dock 164 under its own power or by use of a cable and winch system (manual crank or powered). In an embodiment of the present invention, the transfer conveyor 100 is self-propelled by at least one of its wheels 118, and preferably at least one wheel on each side of the transfer conveyor, so a user may steer the transfer conveyor 100 on the ground by controlling the relative speed of wheels on respective sides of the transfer conveyor.

The dock 164 may be two tracks or rails spaced apart such that the tires 118a-d of the transfer conveyor can engage both tracks simultaneously. In another embodiment, the dock 164 may be a single ramp at least as wide as the transfer conveyor 160. In an embodiment of the present invention, the dock 164 may be mounted on a frame 168 including cross-members extending transversely between the rails of the dock 164. The frame 168 is configured to assist the dock in supporting the weight of the transfer conveyor 100 and in maintaining the orientation and alignment of the rails of the dock 164 when the dock 164 is moving between storage and deployed positions.

The dock 164 may include telescoping members 170a-b (e.g., like the rails shown) including a top member 170a which houses a bottom member 170b. The dock 164 is preferably pivotably coupled to the trailer 152 at a first location and detachably coupled to the trailer 152 at a second location (e.g., via the transfer conveyor). In an embodiment, the dock 164 is coupled to the trailer at the second location by a ratchet and strap assembly 174 that connects the transfer conveyor 100 to the trailer to maintain the dock 164 in a horizontal storage position between the transfer conveyor 100 and the trailer 152. Alternatively, the ratchet and strap assembly 174 may be connected directly to the dock to secure the dock 164 to the trailer 152 in the storage position when the transfer conveyor 100 is not loaded on the trailer.

To move the dock 164 from the storage position to the deployed position, the transfer conveyor is detached from the trailer 152 at the second position allowing the dock to pivot about the first position. Bottom rail members 170b are extended laterally outwardly (relative to the longitudinal axis of the trailer) from respective top rail members 170a. The transfer conveyor 100 is then moved on to the extended bottom members 170b (either by self-propulsion or a winch and cable system, or the like), and the dock 164 is configured such that the shift in weight of the transfer conveyor from the upper members to the extended lower members is sufficient to cause the dock 164 to pivot downwardly until ends of the bottom members 170b contact the ground. In an embodiment of the present invention, a damper (such as a hydraulic, pneumatic or spring cushioned shock absorber) may be positioned between the trailer 152 and the dock 164 to control the rate of descent of the ramp.

In order to move the dock back into a storage position, the transfer conveyor 100 is propelled up or pulled by a powered or manual winch and cable onto the dock 164 until it is on the top members 170b, and the weight of the transfer conveyor 100 causes the dock to pivot into a storage position. In an embodiment, the dock 164 may include wheel stops 166 configured to stop the motion of a transfer conveyor 100 at an end of the dock opposite the open end of the top members 170a. The stops 166 may be plates or protrusions extending upwardly from the dock 164. The dock 164 may also include a hook 172 attached to the trailer 152 and configured to engage a loop or other protrusion on the transfer conveyor 100 when it is driven up the dock 164. The hook 172 and the stops 166 stop the motion of the transfer conveyor 100 when it is driven up the dock into a storage position and assist in maintaining the transfer conveyor 100 in the storage position securely during transport. In an embodiment of the present invention, a second damper may be positioned between the dock 164 and the trailer 152 to control the descent of the dock 164 when moving from the deployed position to the storage position. When the dock 164 has returned to a storage position, the transfer conveyor is coupled to the strap and ratchet assembly 174 to maintain it in position.

FIGS. 7-11 also show the transfer conveyor 100 moving from a storage position to an operating position. An operator may move the transfer conveyor 100 into an operating position by pivoting the second conveyor portion 110 about its first end 114. In an embodiment of the present invention, the second conveyor portion 110 may be manually pivotable about its first end 114. In another embodiment of the present invention, an operator may pivot the second conveyor portion 110 about its first end 114 via a controller, which is described in further detail below. The angle of the longitudinal axis of the second conveyor portion 110 relative to the longitudinal axis of the first conveyor portion 109 may be adjustable such that the height of the discharge 112 may be adjusted.

FIGS. 12-15 illustrate the transfer conveyor in an operating position according to an embodiment of the present invention. In an embodiment, the transfer conveyor 100 is self-propelled and steerable by an operator using a controller. In use, after the transfer conveyor 100 is removed from the trailer, the second conveyor portion 110 is unfolded from the storage position across the top of the receptacle 102 to an operating position extending upwardly and outwardly from the receptacle, preferably at an acute angle relative to the ground. The receptacle 102 of the transfer conveyor 100 is then steered into an operating or loading position under a storage bin 200. The transfer conveyor 100 is positioned such that the opening 104 is positioned to receive material discharged from an opening 202 in the storage bin 200 and the second conveyor portion 110 extends upwardly and outwardly from the storage bin. The conveyor portions 109 and 110 are then switched on and the discharge of the storage bin 200 opened to allow material to flow from the bin into the receptacle 102. The material discharged from the storage bin 200 enters the receiving area 106, which directs the discharged material to the first conveyor portion 109. The first conveyor portion 109 conveys the material to the second conveyor portion 110, and the second conveyor portion 110 discharges the material. As shown, the seed tender conveyor 156 of the seed tender 150 may be positioned such that its input 158 receives the material discharged from second conveyor portion 110. The material received by the input 158 of the conveyor is discharged into the bin 154 of the seed tender.

Once a desired amount of material has been transferred, the bin discharge is closed and the conveyor portions are turned off. The transfer conveyor may then be steered out from underneath the storage bin and the second conveyor portion folded into the storage position. The transfer conveyor may then be steered to the trader and made to climb the ramp until it is in the storage or transport position.

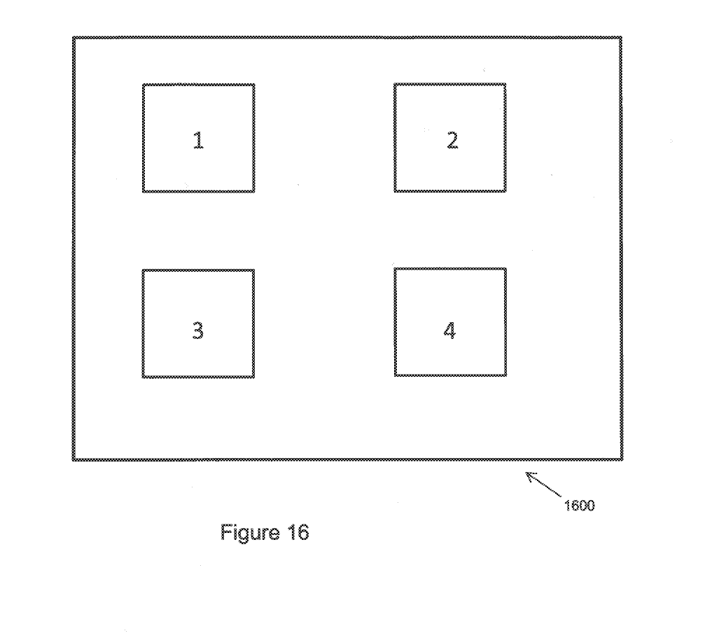

FIG. 16 illustrates a controller for a transfer conveyor according to an embodiment of the present invention. The controller 1600 includes a plurality of control members 194 configured to control different functions of the transfer conveyor 100. In an embodiment of the present invention, a first control member 1 may control movement of the rear wheels 118a-b for the transfer conveyor 100. The first control member 1 may be configured to control each rear wheel 118a-b independently such that one wheel may rotate faster, or even in an opposite direction, than the other wheel. In an embodiment of the present invention, each rear wheel 118a-b is driven by its own motor (e.g., hydraulic motor), and control member 1 is configured to control each of the rear wheel motors independently. The first control member 1 may be a toggle or joystick for each wheel,

A second control member 2 may control operation of the conveyor members housed in the first conveyor portion 109 and the second conveyor portion 110. For example, the second control member 2 may be a switch or knob to turn the conveyor members on and off. A third control member 3 may control the speed of the conveyor members when they are in operation. The third control member 3 may be a toggle or joystick. In an embodiment of the present invention, the same control member may turn the conveyor on and off and control the speed of the conveyor. The fourth control member 4 may be configured to control pivoting or folding of the second conveyor portion 110 about its first end 114. The fourth control member 4 may be used to move the second conveyor portion 110 from a storage position to an operating position, and, in the operating position, control the height of the spout 112 via the angle of the second conveyor portion 110. The controller 1600 may be on board the transfer conveyor 100 or it may be separate from the transfer conveyor 100 and coupled via a cord or wirelessly (e.g., using radio frequency signals).

From the above it will be appreciated that the transfer conveyor and the farm implement for transporting the same of the present invention allows a transfer conveyor to be transported to a work location on the same farm implement with which it will be operating. It will also be appreciated that various changes can be made to the system without departing from the spirit and scope of the appended claims. For example, the transfer conveyor may be propelled by tracks or treads instead of wheels. In another example, the conveyor portions or members in the transfer conveyor can be belt conveyors, screw augers or pneumatic conveyors. In a further example, the motors can be gas, electric or hydraulic drive motors, or some combination of the foregoing types of drive motors. In another example, the transfer conveyor can be used to transfer material from stationary bins or containers or bins or containers on trucks, trailers or rail cars. In a further example, the transfer conveyor can be used to transfer various types of agricultural materials, including, without limitation, seed, grains, fertilizer, feed, etc. These and other modifications are intended to be encompassed within the scope of the appended claims.

We claim:

1. A transfer conveyor for transport on a farm implement with a trailer including a dock configured to store the transfer conveyor, comprising:
a receptacle defining a receiving area with an open top;
a first conveyor portion disposed in said receiving area and configured to move material in said receiving area along an axis; and
a second conveyor portion having an end pivotably coupled to the receptacle adjacent an opening in a side or bottom of said receptacle,
wherein the second conveyor portion is pivotable between a storage position in which the second conveyor portion is positioned across the open top of the receptacle and an operating position in which the second conveyor portion extends outwardly from the receptacle.

2. The transfer conveyor of claim 1, further comprising a plurality of wheels mounted on the receptacle.

3. The transfer conveyor of claim 2, further comprising a drive motor configured to drive at least one of the plurality of wheels.

4. The transfer conveyor of claim 1, wherein an angle of the second conveyor portion relative to the axis of the first conveyor portion is adjustable in the operating position.

5. The transfer conveyor of claim 1, wherein the receptacle also includes a sump at the bottom of the receiving area and the first conveyor portion is configured to convey material from the sump.

6. The transfer conveyor of claim 1, wherein the receptacle further includes a coupling member which protrudes from the top of the receptacle adjacent the open top, and the second conveyor portion is pivotably coupled to the coupling member.

7. A system for transferring material from a storage container to a farm implement, comprising:
a farm implement including a trailer, a bin mounted on the trailer, a dock mounted on the trailer and a cart conveyor including an input and output, wherein the cart conveyor is positionable in a cart loading position in which the cart conveyor output is positioned over the bin;
a transfer conveyor including a receptacle defining a receiving area with an open top;
the transfer conveyor further including a second conveyor having a first end coupled to the receptacle adjacent an opening in the side or bottom of said receptacle,
wherein the second conveyor is pivotable between a storage position in which the second conveyor is positioned across the top of the receptacle and an operating position in which the second conveyor extends outwardly from the receptacle,
wherein the transfer conveyor is configured to be moved on and off the dock.

8. The system of claim 7, wherein the transfer conveyor receptacle includes a plurality of wheels.

9. The system of claim 8, wherein at least one of the plurality of wheels propels the conveyor.

10. The system of claim 7, wherein an angle of the second conveyor relative to the longitudinal axis of the first conveyor is adjustable in the operating position.

11. The system of claim 7, wherein the transfer conveyor receptacle also includes a sump at the bottom of the receiving area and the first conveyor is configured to conveyor material from the sump.

12. The system of claim 7, wherein transfer conveyor receptacle further includes a coupling member which protrudes from the top of the receptacle adjacent the open top, and the second conveyor is pivotably coupled to the coupling member.

13. The system of claim 7, wherein the dock is moveable between a storage position and a deployed position.

14. The system of claim 13, wherein the dock is extendable, and wherein in the deployed position the dock is extended until an end of the dock contacts a ground.

15. The system of claim 7, wherein the trailer includes a plurality of support members including a cavity in which the dock is positioned.

16. The system of claim 7, wherein a height of the transfer conveyor is less than a distance between the dock and the cart conveyor when the cart conveyor is in a transport position,

17. A farm implement for transporting a transfer conveyor, comprising:
a trailer;
a bin mounted on the trailer;
a conveyor positionable in a loading position in which a conveyor output is positioned over the bin; and
a dock mounted on the trailer and configured to support a transfer conveyor, wherein the dock is moveable between a storage position and a deployed position in which the dock is inclined and an end of the dock contacts a ground.

18. The farm it of claim 17, wherein the dock is extendable.

19. The farm implement of claim 17, wherein the trailer includes support members including a cavity in which the dock is mounted.
